(19) United States
(12) Patent Application Publication
(10) Pub. No.: US 2026/0278505 A1
(43) Pub. Date: Sep. 17, 2026

(54) GENERATIVE ARTIFICIAL INTELLIGENCE BASED WORKFLOW ACTIVITES

(71) Applicant: Adobe Inc., San Jose, CA (US)

(72) Inventors: Rishabh PURWAR, Faridabad (IN); Khyathi VAGOLU, Hyderabad (IN); Himanshu GUPTA, Noida (IN); Gaurav BHARGAVA, Noida (IN); Ayush GUPTA, Meerut (IN)

(21) Appl. No.: 19/077,481

(22) Filed: Mar. 12, 2025

(51) Int. Cl. G06Q 10/0631; G06F 16/21

(52) U.S. Cl. CPC G06Q 10/0633; G06Q 10/06316; G06Q 10/06334; G06F 16/211

(57) ABSTRACT

In various examples, a workflow assistant tool utilizes a machine learning model to automate the creation and modification of workflow activities for an application based in a natural language input. For example, the workflow assistant tool leverages natural language processing (NLP) and machine learning models to interpret user queries, generate discrete segments and conditions, identify relevant data schemas, and produce executable data objects in a domain-specific language. In another example, the workflow assistant tool includes a multistep Retrieval-Augmented Generation-based prompt engineering pipeline in addition to schema filtering, segment and condition generation, and validation and correction mechanisms to generate workflow activities based on natural language inputs from a user.

### BACKGROUND

Users often rely on analytics services to collect and analyze data. Such analytics services can provide insights based on analyzed data. Users, in particular, use analytics services to conduct analytics sessions on data (e.g., user clickstream data) while attempting to gain insights. By way of example, an analytics service can answer questions, such as which mobile devices make the most product conversions. The analytics service can also quantify the success of a marketing campaign. However, a user (e.g., a data analyst) of the analytics services must make many decisions when it comes to gathering insights from an increasing amount of data and capabilities in processing the data, and the user needs to have the ability to quickly query, analyze, and draw inferences from the data. As such, machine learning models are useful tools that when integrated into the analytics service can help users gather insights by filtering, collecting, reviewing, or otherwise interacting with the data and capabilities of the analytics services.

For example, various types of artificial intelligence (AI) models can perform various tasks such as interpreting natural language prompts and generating outputs based on the natural language prompts. These large language models (LLMs) can be trained on a large corpus of data and extract or otherwise generate responses to questions related to the large corpus of data. For example, an LLM can be integrated with the analytics services to facilitate querying, analyzing, and drawing inferences from the data maintained by the analytics services.

### SUMMARY

Embodiments described herein are directed to a workflow assistant tool that uses a machine learning model to generate and/or modify workflow activities for various marketing and/or analytics services based on natural language (NL) queries provided by a user. Furthermore, in such embodiments, the workflow assistant tool leverages natural language processing (NLP) and machine learning models to automate the generation of workflows (e.g., without user intervention), allowing users to create, edit, or otherwise manage workflows using natural language queries without the need to compose the workflows themselves and/or the technical expertise to interact with the functions and/or operations provided by the various marketing and/or analytics services. For example, a machine learning model processes the user queries and generates discrete segments based on tasks described in the user queries. Continuing this example, the workflow assistant tool identifies relevant data schemas (generating specific conditions and functions), causes the machine learning models to process the discrete segments, validates the output of the machine learning model, corrects errors, and provides to the user an executable data object in a domain-specific language to enable the user to execute the workflow within the various marketing and/or analytics services.

In various embodiments, the workflow assistant tool includes a multistep Retrieval-Augmented Generation (RAG)-based prompt engineering pipeline that interprets natural language queries and generates fully configured workflow activities. For example, the workflow assistant tool obtains user input processing (e.g., a natural language query), and expands the user prompt into segments containing one or more conditions using a large language model (LLM). In addition, in various embodiments, the workflow assistant tool performs schema filtering to identify the relevant schemas (e.g., database tables) based on a task extracted from the user input. For example, semantic vector embeddings are generated from various database schemes and that user input. The semantic vector embeddings are then compared using cosine similarity to determine the schemas relevant to the user input.

Furthermore, in various embodiments, the workflow assistant tool determines one or more conditions for the segments extracted from the user input. For example, the conditions include an enrich condition, a functional condition, a filter condition, and a sort condition determined using the LLM, a set of predefined rules, and/or other machine learning models. In various embodiments, the workflow assistant tool creates compact representations of filtering conditions to optimize token usage. For example, the compact representations are included in a prompt that when provided to the LLM, causes the LLM to generate the workflow activity without exhausting and/or exceeding the token limit. In addition, the workflow assistant tool, in various embodiments, converts the tasks described in the user query to a domain-specific language (DSL). For example, tokens are generated based on the segments and conditions within the segments using regular expressions. Continuing this example, the tokens are then converted to the DSL. In various embodiments, the workflow assistant tool also performs validation and correction operations that ensure the accuracy of generated conditions. For example, the workflow assistant tool cross-references schema lists and corrects errors. Finally, in various embodiments, the workflow assistant tool combines those validated and corrected segments into a single DSL output (e.g., a data object such as a JavaScript Object Notation [JSON] file), which includes the workflow activity indicated in the user input.

### BRIEF DESCRIPTION OF THE DRAWINGS

The present disclosure is described in detail below with reference to the attached drawing figures, wherein:

FIG. 1 depicts an environment in which one or more embodiments of the present disclosure can be practiced.

FIG. 2 depicts an environment in which a workflow assistant tool generates a structured data object corresponding to a workflow activity described in a natural language prompt, in accordance with at least one embodiment.

FIG. 3 depicts a user interface that accepts a natural language prompt is provided to the workflow assistant tool, in accordance with at least one embodiment.

FIG. 4 depicts a user interface displaying a workflow activity generated based on a natural language prompt, in accordance with at least one embodiment.

FIG. 5 depicts a user interface displaying a workflow activity generated based on a natural language prompt, in accordance with at least one embodiment.

FIG. 6 depicts a user interface accepts a natural language prompt is provided to the workflow assistant tool, in accordance with at least one embodiment.

FIG. 7 depicts an example process flow for generating a workflow activity based on a natural language prompt, in accordance with at least one embodiment.

FIG. 8 is a block diagram of a Large Language Model that uses particular inputs to make particular predictions, according to some embodiments.

FIG. 9 is a block diagram of an example computing environment in which embodiments described herein may be employed.

### DETAILED DESCRIPTION

Various terms are used throughout this description. Definitions of some terms are included below to provide a clearer understanding of the ideas disclosed herein.

As used herein, the term “analytics service” and/or “marketing service” refers to cloud computing services that provide users access to data that is used to generate insights. For example, the analytics service collects, processes, and provides operations that help users gain insights and make decisions. In one example, the analytics service collects marketing campaign data and allows users to process this data to gain insights into successful marketing campaigns. Furthermore, the analytics service, for example, is accessible to the user through an application and can perform various operations using the data to generate content that enables users to determine insights associated with the data. In an embodiment, the analytics service is a service that is capable of tracking, measuring, and analyzing data, such as website traffic and customer behavior. In one example, the analytics service provides user access to a workflow that is used to interact with data maintained by the service. In this way, an analytics service may collect or obtain data from various channels, such as websites, mobile applications, videos, social media, etc. Continuing with this example, through the workflow, the user can interact with the analytics service and breakdown, filter, query, and visualize data. As such, the analytics service may provide real-time data analysis such that various insights related to user interactions, campaign performance, and/or content engagement may be viewed. Various features of an analytics service may include, by way of example only, user journey analysis and conversion analysis (e.g., in association with particular channels or campaigns), predictive insights (e.g., forecasting trends or issues), customized metrics to enable tailored information, and/or the like.

As used herein, the term “workflow” refers to a sequence of tasks or activities that are organized and executed to achieve a specific goal or complete a particular process. Furthermore, in some examples, a workflow involves the systematic arrangement of steps, where the steps represent a distinct action and/or operation to be performed (e.g., by an application and/or service frontend). In an embodiment, the workflows define a process and/or data flow between one task to another, specifying the order in which tasks should be completed and the dependencies between them. By way of example, the user provides a natural language query to the machine learning model which, in response, populates the workflow with a particular workflow activity to accomplish the tasks and/or subtasks indicated in the natural language query. In various embodiments, the workflow includes a set of segments and a set of conditions corresponding to features, operations, and/or tools provided by the application and/or the analytics service. For example, the workflow includes a first workflow activity to analyze data, a second workflow to perform audience segmentation, and a third workflow activity to generate a personalized email for the audience segment.

As used herein, the term “workflow activity” refers to a discrete, configurable unit within a workflow that performs a specific function or task. For example, a particular workflow activity represents an individual step in a sequence of actions designed to achieve a particular goal or complete a process represented by a workflow. In various embodiments, workflow activities include operations such as data enrichment, filtering, sorting, sending notifications, or executing business logic. In one example, a workflow activity is defined by its inputs, outputs, and the conditions under which it operates. In the context of marketing and analytics services, for example, workflow activities enable the automation and orchestration of tasks, allowing users to create, edit, and manage complex workflows. In various embodiments, users provide natural language inputs to the workflow assistant tool to cause the machine learning model to generate workflow activities.

As used herein, the term “workflow assistant” refers to a user interface element of an application that allows a user to interact with a machine learning model. By way of example, the workflow assistant includes a query box, a chat box, and/or other interface that allows the user to submit queries (e.g., natural language questions) and obtain workflow activities generated by a machine learning model. Continuing this example, the workflow assistant provides an interactive interface allowing users to input a natural language query to the machine learning model to facilitate the processing of data and/or generation of workflow activities. In various embodiments, the workflow assistant includes various user interface elements to facilitate interactions with the machine learning model such as: a message area where queries from the user and response from the machine learning model are displayed; an input box to provide natural language queries and/or prompts; a send button to submit natural language queries and/or prompts; and a workspace to view, edit, create, and/or execute workflows.

As used herein, the term “workflow assistant tool” refers to an application service, or other executable code that is integrated with the application, the marketing service, and/or the analytics services and provides a machine learning model that generates workflow activities based on input from the user and data maintained in database tables. For example, the workflow assistant tool is integrated into the application (e.g., through the workflow assistant user interface element) and the analytics service, allowing the user to provide queries through the workflow assistant of the application, and in turn, the workflow assistant tool causes the machine learning model to generate workflow activities that perform operations on data.

A “query” refers to text that is used as input to a machine learning model that instructs the machine learning model to produce a specific workflow activity to process data maintained in a database or other data store. In one example, a query is obtained from the user and a prompt to the machine learning model is generated based on the query. In other examples, the query is provided directly to the machine learning model as the prompt.

As used herein, the term “Retrieval-Augmented Generation” (RAG) refers to a technique that enhances the capabilities of machine learning models by incorporating information retrieval. For example, RAG modifies interactions with a large language model (LLM) so that the LLM responds to user queries by referencing a specified set of documents, using this information to augment the data drawn from its own training. This allows LLMs to provide more accurate and domain-specific responses by leveraging external, up-to-date information. In various embodiments, RAG is used to generate prompts to enable the machine learning model of the workflow assistant tool to generate workflow activities based on augmented data. For example, the machine learning model is augmented with information defined by a representation of segments and conditions for the workflow activities.

As used herein, the term “segment” refers to atomic tasks indicated in the natural language user input extracted by the machine learning model of the workflow assistant tool. For example, a task, represented in a segment, is a discrete operation and/or function that is capable of being performed independently of other tasks. For example, if a user provides a query such as “customers who purchased products in the last 30 days,” the segment includes query recent purchasers. In various embodiments, the segments correspond to tasks identified by the machine learning model based on the user input. For example, the user can provide a natural language prompt describing a workflow activity that can be include a plurality of segments.

As used herein, the term “condition” refers to atomic subtasks associated with the segments indicated in the natural language user input extracted by the machine learning model of the workflow assistant tool. In various embodiments, the conditions correspond to specific functions and operations required to execute the tasks represented by the segments. For example, conditions include various types such as enrich conditions, functional conditions, filter conditions, and sort conditions. Continuing the example above, in the segment “identifying recent purchasers,” the conditions include a function to search the database for customers who purchased products and a function to filter the search results by purchases in the last 30 days. In various embodiments, the conditions correspond to specific operations and/or functions provided by the application, the marketing service, and/or the analytics service.

As used herein, the term “relevant schema” refers to the specific database schema that contains the tables and columns pertinent to a given workflow activity. In one example, identifying the relevant schema involves determining which parts of the database hold the necessary data to fulfill the conditions and/or segments generated by the machine learning model based on the natural language input provided by the user. For example, if a user wants to create a workflow that involves sending personalized emails to customers who made purchases in the last month, the relevant schemas might include tables that store customer information, purchase history, and email tracking logs. In various embodiments, the relevant schemas enable the machine learning model to accurately retrieve and process the data needed to execute the workflow activity.

Conventional systems for configuring workflow activities in marketing and analytics services are often complex and time-consuming. These systems require users to have a deep understanding of user interfaces, internal structures, and data models. Furthermore, the process of manual setting up parameters, identifying tables and columns, determining relationships, and applying functions and operators can be tedious and is error-prone. In addition, different marketing services and/or analytics services provide different functions, operations, and user interfaces that add to the complexity of setting up workflows. Furthermore, these different services operate using domain-specific languages, and knowledge or experience using one service does not necessarily translate to other services.

In addition, modern computing systems maintain, track, store, and generate large amounts of data that can be stored in various data stores. For example, customer data and sales data can be updated and generated frequently. In addition, this data is often stored in different databases using different schemas that can add to the complexity and amount of knowledge required by users to configure and generate workflows. Furthermore, database tables, in modern computing environments, can link to other databases using different schemas, which are not necessarily intuitive and/or user-friendly. Therefore, determining the location of relevant data when generating workflow activities adds additional layers of complexity requiring further technical expertise to efficiently and easily configure these workflow activities.

This complexity results in a steep learning curve and significant time investment, making it challenging for users to efficiently create and manage workflows. In general, this shortcoming is particularly challenging because users of these services are generally non-technical users with experience, training, and backgrounds in other fields. For example, users of these various marketing and analytics services often have backgrounds and experience in business and advertising with little to no experience in computer engineering and computer programing. Conventional systems provide little to no automated support for workflow generation and, therefore, require these users to take the time to learn the technical aspect of these services. For example, users may be required to search a knowledge base or technical descriptions of various functions and operations provided by these services.

In contrast, embodiments described herein include a generative artificial intelligence (AI)-based workflow assistant tool that utilizes natural language processing (NLP) to automate, on behalf of the user, the generation of workflow activities. This workflow assistant tool allows users to create and manage workflows using simple natural language queries provided through a user interface, significantly reducing the time and complexity involved in workflow configuration. For example, workflow assistant tools help process, digest, understand, query, or otherwise interact with documentation, websites, the Internet, or other collections of documents to help the user generate, configure, and/or modify workflow activities for the different marketing and analytics services. For example, a machine learning model, such as an LLM, is trained and used as an AI assistant to enable users to interact with the LLMs and perform various operations in connection with workflows corresponding to particular marketing and/or analytics services.

Accordingly, embodiments described herein generally relate to a multistep Retrieval-Augmented Generation (RAG)-based prompt engineering pipeline of the workflow assistant tool that interprets natural language queries and generates workflow activities encoded or otherwise stored in a structured data object such as JavaScript Object Notation (JSON) format. For example, a user can request to create a workflow that sends personalized emails to customers based on their purchase history and engagement with previous campaigns. The workflow assistant tool processes this query, identifies the necessary data, generates the tasks represented as segments and subtasks represented as conditions, and configures the workflow without additional user input. This approach not only enhances efficiency and accuracy but also makes workflow configuration accessible to non-technical users, providing a scalable and cost-effective solution for these various services.

In one example, the process begins with obtaining a user input (e.g., a natural language query inputted into a user interface of an application) and processing the user input by at least expanding the user input into discrete segments including conditions using a large language model (LLM). In various embodiments, the segments represent atomic tasks (e.g., independent tasks) indicated in the user input (e.g., the segment includes a task and/or subtask that can be perform independently of other tasks and/or subtasks). For example, a user might provide a query such as “Enrich with customers who purchases products in the last 30 day, sorted by cost of the products, and who have opened at least one previous email campaign.” Continuing this example, the LLM interprets this query and identifies a set of segments such as enrich within purchase details of recipients, enrich with email campaign details of recipients.

Furthermore, in various embodiments, the segments include a set of conditions that correspond to particular functions and/or operations of the service executing the workflow. Returning to the example above, the segment associated with “enrich within purchase details of recipients” includes a set of conditions corresponding to operations such as a function to filter results from a database (e.g., “filter purchases made in the last 30 days”) and a function to sort the filtered search results (e.g., “sort purchases details in descending order of cost of product”). In various embodiments, the conditions are determined by the LLM and represent atomic subtasks of the set of tasks represented by the segments. Furthermore, the segments and conditions of the segments, in an embodiment, are executed in parallel to reduce processing time. In other embodiments, one or more segments and/or conditions are executed in serial.

In addition, in various embodiments, the workflow assistant tool performs schema filtering to identify relevant schemas based on the result of generating the segments and conditions. For example, by expanding and breaking down the user input into a set of segments, the LLM or other machine learning model generates semantic vector embeddings representing the segments and the conditions. Furthermore, in various embodiments, vector embeddings are generated based on the database schemas and/or annotations associated with the database schemas. Continuing the example above, the cosine similarity between the semantic vector embeddings generated by the LLM based on the user input and vector embeddings of the database schemas is determined and used to select relevant database tables. For instance, a comparison of vector embeddings identifies tables “CustomerID,” “PurchaseDate,” and “EmailID” from the database as including data to execute a particular condition extracted from the user input (e.g., “customers who purchased products”).

In various embodiments, the conditions include enrich, functional, filter, and sort conditions that are determined based on the LLM and/or a set of rules. Furthermore, in such embodiments, the conditions are generated by a machine learning model (e.g., an LLM) in domain-specific language (DSL) or other format such as extensible markup language (XML). In the example above, conditions include “PurchaseDate>=TODAY( )−30” for purchase history information indicated in the user input and “OpenDate IS NOT NULL” for email engagement information indicated in the user input. The workflow assistant tool, in an embodiment, generates compact representations of various conditions to optimize token usage when generating prompts to input to the LLM. For example, the LLM is provided with a set of steps for generating the compact representation such as defining a conditional hierarchy, breaking down a task, selecting operators, combining conditions, and representing the query expression in a structured format.

In an embodiment, the output of the LLM is used to convert the workflow generated by the user query to the DSL. For example, the tokens included in the output are parsed and used to generate the DSL in JSON format. In various embodiments, once the workflow is generated, the workflow assistant tool performs validation and correction to ensure the accuracy of generated conditions by cross-referencing schema lists and correcting errors. For example, the workflow assistant tool parses the workflow activity to detect missing or incorrect linking between schemas and/or schema columns, invalid schema and/or column names, and invalid functions. Finally, in various embodiments, the workflow assistant tool combines those validated and corrected segments into a single output corresponding to the workflow activity indicated in the user query.

Advantageously, embodiments described herein enable users to generate workflow activities with improved ease and efficiency, enhanced accuracy, scalability, user-friendliness, and cost-effectiveness. For example, by leveraging generative AI and a multistep RAG-based prompt engineering pipeline, the workflow assistant tool ensures the accuracy of the generated workflows, reducing the likelihood of errors. The workflow assistant tool, in various embodiments, processes a wide range of natural language queries and generates various workflow activities, making it scalable for different use cases and/or services. Additionally, the workflow assistant tool allows users to configure, generate, and/or modify workflow activities using simple natural language queries, eliminating the need for a deep understanding of the user interface and internal schema structures. This approach not only enhances efficiency and accuracy but also makes workflow configuration accessible to non-technical users, providing a scalable and cost-effective solution for various industries.

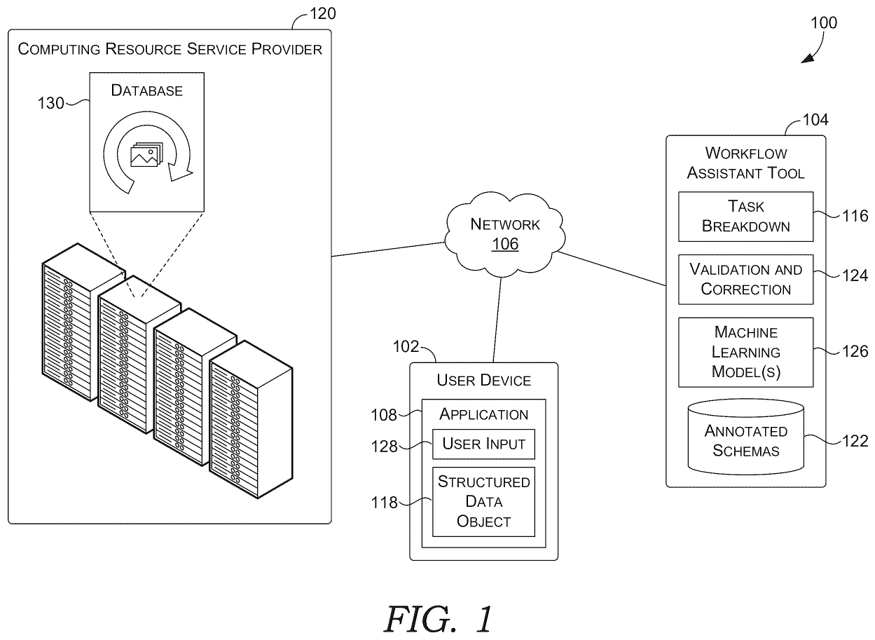

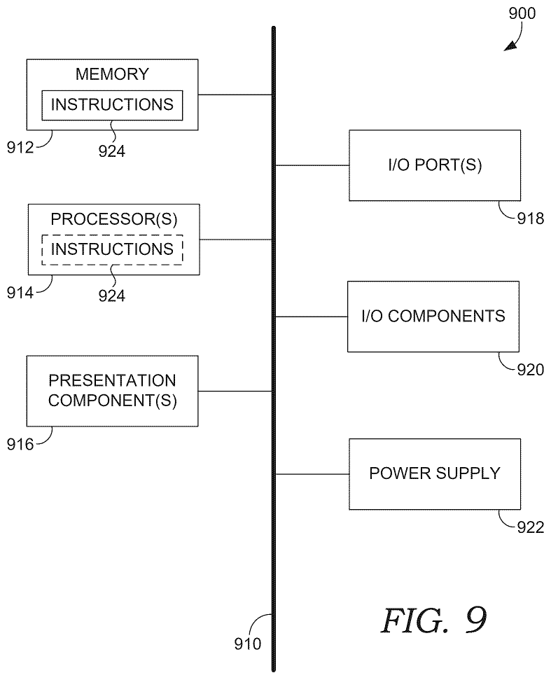

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 9.

It should be understood that operating environment 100 shown in FIG. 1 is an example of one suitable operating environment. Among other components not shown, operating environment 100 includes a user device 102, a workflow assistant tool 104, and a network 106. Each of the components shown in FIG. 1 can be implemented via any type of computing device, such as one or more computing devices 900 described in connection with FIG. 9, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the workflow assistant tool 104 includes multiple server computer systems cooperating in a distributed environment to perform the operations described in the present disclosure. Continuing this example, the workflow assistant tool 104 includes a machine learning model 126 executed by a server computer system of the computing resource service provider 120 and an annotated schema 122 data store generated based on a database 130 provided by the computing resource service provider 120 to users such as a user operating the user device 102 through the application 108.

User device 102 can be any type of computing device capable of being operated by an entity (e.g., individual or organization) and that obtains data from the workflow assistant tool 104 and/or a data store that can be facilitated by the workflow assistant tool 104 (e.g., a server operating as a frontend for the data store) and/or the computing resource service provider 120 (e.g., the database 130). The user device 102, in various embodiments, has access to or otherwise maintains the database 130, which stores data useable for marketing and/or analytics. For example, the application 108 executes workflow activities using data maintained in the database 130 to generate marketing and/or analytics information for a user.

In various embodiments, workflow activity is a discrete, defined task or set of tasks within a larger workflow process that is designed to achieve a specific objective. For example, a marketing service and/or analytics service utilizes workflow activities to perform various operations such as data retrieval, data enrichment, filtering, sorting, and executing specific actions based on predefined conditions. In an embodiment, a workflow activity, when executed by the application 108 and/or other component illustrated in FIG. 1 (e.g., the computing resource service provider 120), interacts with relevant data schemas, applies specific conditions, and produces desired outcomes. For example, a workflow activity retrieves customer purchase data, filters by customers who made purchases in the last 30 days, enriches customer profiles with additional information, and sends personalized email campaigns to the filtered customers.

In various embodiments, the user can leverage workflow activities to automate complex processes, streamline operations, and enhance efficiency. For example, by defining and configuring workflow activities, users can automate repetitive tasks, ensure consistency in data processing, determine insights from data, track customer activity, generate marketing campaigns, and achieve accurate and timely results. In an embodiment, workflow activities enable users to create sophisticated workflows that can handle a wide range of tasks, from data queries to multistep processes that query data and perform operations.

In some implementations, user device 102 is the type of computing device described in connection with FIG. 9. By way of example and not limitation, the user device 102 can be embodied as a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice.

In various embodiments, the application 108 includes any application capable of facilitating the exchange of information between the user device 102 and the workflow assistant tool 104. For example, the application 108 is an analytics application that tracks, analyzes, and/or optimizes various interactions with customers across multiple communication channels and over an interval of time. Continuing this example, the application 108 provides data integration, journey mapping, segmentation and personalization, predictive analytics, journey optimization, and reporting and dashboards to provide users with tools to make data-driven decisions. In some implementations, the application 108 comprises a web application, which can run in a web browser, and can be hosted at least partially on the server-side of the operating environment 100. In addition, or instead, the application 108 can comprise a dedicated application, such as an application being supported by the user device 102 and/or workflow assistant tool 104. In some cases, the application 108 is integrated into the operating system (e.g., as a service). It is therefore contemplated herein that “application” be interpreted broadly. Some example applications include ADOBE® Customer Journey Analytics, a cloud-based analytics service.

For cloud-based implementations, for example, the application 108 is utilized to interface with the functionality implemented by the workflow assistant tool 104 and/or computing resource service provider 120. In some embodiments, the components, or portions thereof, of the workflow assistant tool 104 are implemented on the user device 102 or other systems or devices. Thus, it should be appreciated that the workflow assistant tool 104, in some embodiments, is provided via multiple devices arranged in a distributed environment that collectively provide the functionality described herein. Additionally, other components not shown can also be included within the distributed environment.

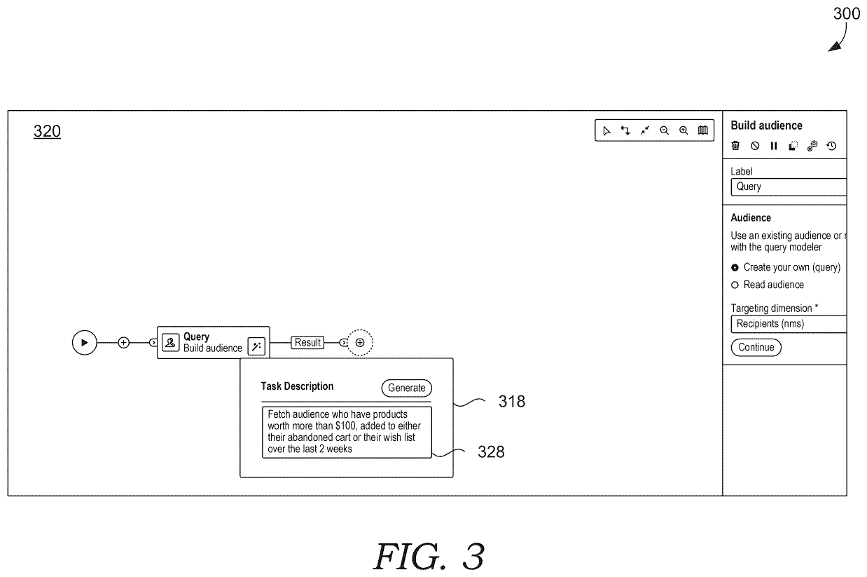

As illustrated in FIG. 1, the user device 102 obtains a user input 128 through the application 108. For example, a user interface of the application 108, as illustrated below in FIG. 3, provides a text box or other user interface element to enable the user to provide the user input 128. In various embodiments, the user input 128 includes natural language queries provided by users that are utilized by the workflow assistant tool 104 to generate workflow activities encoded or otherwise stored in a structured data object. For example, the user input 128 is processed by the workflow assistant tool 104 to interpret, determine, or otherwise obtain the user's intent and break down the user input 128 into manageable tasks (e.g., during a task breakdown 116 operation).

In an embodiment, the user input 128 includes conversational command that specifies an outcome of a particular workflow activity. For example, a user might input a query such as “Create a workflow to send personalized emails to customers who purchased products in the last 30 days and have opened at least one previous email campaign.” The application 108 and/or user device 102, in various embodiments, provides the user input 128 to the workflow assistant tool 104 to enable the workflow assistant tool 104 to generate a workflow activity based on the user input 128. In such embodiments, the workflow assistant tool 104 utilizes one or more machine learning model(s) 126 to perform various tasks to generate the workflow activity and the structured data object 118 that, as a result of being executed by the application 108 and/or other component illustrated in FIG. 1 (e.g., computing resource service provider 120 and/or database 130), causes the workflow activity to be executed.

In one example, the workflow assistant tool 104 causes a large language model (LLM) to expand the user input 128 into a set of segments where a segment of the set of segments includes a set of conditions. In an embodiment, the set of segments and set of conditions identifies key tasks and subtasks that are atomic relative to other tasks and subtasks identified by the LLM based on the user input 128. For example, atomic tasks and/or subtasks include retrieving customer purchase data, filtering customers based on purchase date and email engagement, and/or configuring the email campaign.

In various embodiments, the workflow assistant tool 104 may be or include any number of machine learning models or technologies. In some embodiments, the workflow assistant tool 104 may include, or access, an LLM that takes, as input, the user input and provides, as output of the task breakdown 116 operation, the set of segments and the set of conditions. A language model is a statistical and probabilistic tool that determines the probability of a given sequence of words occurring in a sentence (e.g., via next sentence prediction [NSP] or masked language modeling [MLM]). In this way, it is a tool that is trained to predict the next word in a sentence. A language model is called a large language model when it is trained on an enormous amount of data. Some examples of LLMs are Open Pre-trained Transformer (OPT), Fine-tuned Language Net-Text-to-Text Transfer Transformer (FLAN-T5), Bidirectional and Auto-Regressive Transformers (BART), GOOGLE's® Bidirectional Encoder Representations from Transformers (BERT), and OpenAI's® Generative Pre-trained Transformer 2 (GPT-2), GPT-3, and GPT-4. For instance, GPT-3 is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. In embodiments, an LLM generates representations of text, acquires world knowledge, and/or develops generative capabilities. As described, in some embodiments, the workflow assistant tool 104 takes on the form of an LLM, but various other machine learning models can additionally or alternatively be used.

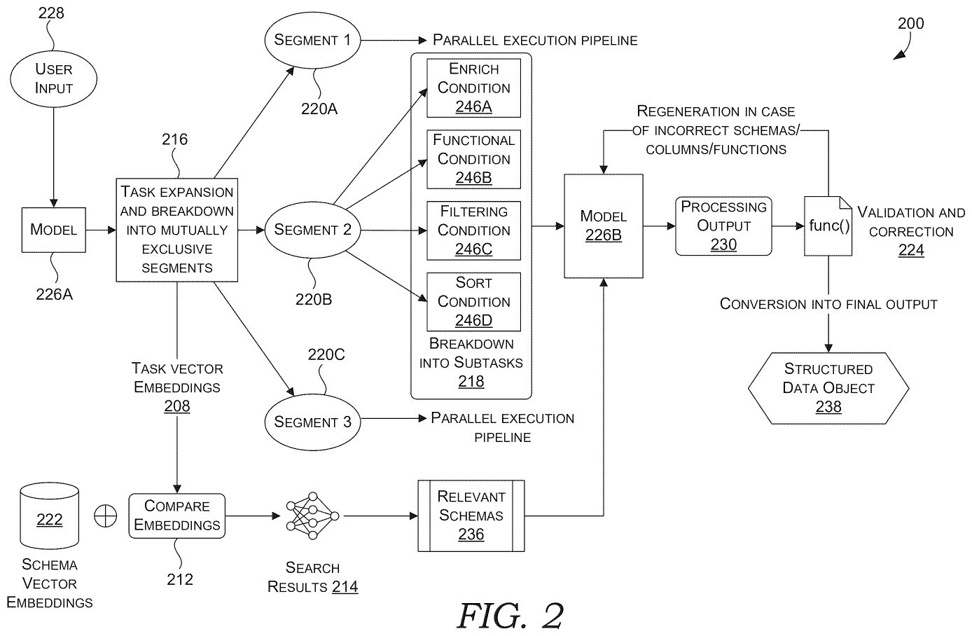

In embodiments, the machine learning model 126 is fine-tuned. For example, fine-tuning generally refers to the process of retraining a pre-trained model on a new dataset without training from scratch. Continuing this example, fine-tuning typically takes weights of a trained model and uses those weights as the initialization value, which is then adjusted during fine-tuning based on the new dataset. Fine-tuning can be used in cases in which an industry-specific dataset exists that can be used to fine-tune the model. In some implementations, the LLM is fine-tuned on various video summaries to leverage its text generation ability in association with video summaries. In various embodiments, the same machine learning model or distinct machine learning models can perform the inferencing operations and/or other operations executed and/or performed by the workflow assistant tool 104. For example, a single LLM performs the task breakdown 116 of the user input and generates the structured data object 118 as a final output of the workflow assistant tool 104. In other examples, such as those described below in connection with FIG. 2, different instances of the same machine learning model (e.g., GPT-4) execute the segments in parallel to perform various operations, such as the sort condition, filter condition, enrich condition, and/or functional condition.

In various embodiments, the database 130 includes a relational database management system (RDBMS), which organizes data into tables with predefined schemas. For example, a table represents a specific entity, such as customers, purchases, or email engagements, and contains columns that define the attributes of that entity. Continuing this example, a “Customer Table” includes columns that store attributes such as name, email, phone number, and address. In various embodiments, the columns of the tables stored in the database 130 include values (e.g., data) that is used during execution of the workflow activities. Returning to the example above, a “Purchase History Table” includes columns such as name, purchase date, product, and purchase amount. Continuing this example, this table is linked to the “Customer Table” through the name column.

In various embodiments, the schemas for the database 130 are annotated with natural language descriptions to provide detailed information about columns and their relationships with other tables. For example, during schema generations users are asked to provide a description of the columns and/or table. In other examples, the schemas are provided as input to an LLM, which is prompted to extract semantic information from the schemas and generate annotations. In various embodiments, the workflow assistant tool 104 generates semantic vector embeddings for the schema (e.g., tables and/or columns of the database 130) using the machine learning model 126 and stores the semantic vector embeddings in the annotated schemas' 122 data store. For example, the semantic vector embeddings capture the semantic meaning of the tables and corresponding columns and are stored in a vector database.

In various embodiments, semantic vector embeddings of the segments and conditions are generated by machine learning model 126 during task breakdown 116 operations. Returning to the example above, in response to the user providing a natural language query (e.g., the user input 128), the workflow assistant tool 104 computes the cosine similarity between the embeddings of the user input 128 (e.g., the segments and conditions) and the embeddings of the tables (e.g., the embeddings stored in the annotated schema's 122 data store) to identify the most relevant tables for the tasks and/or subtasks indicated in the user input. In various embodiments, the tables with the highest similarity score or a similarity score above a threshold are determined to be relevant and used during generation of the workflow activity.

In various embodiments, once the relevant tables are determined, the workflow assistant tool 104 generates the workflow activity based on the segments and conditions extracted from the user input 128. For example, the user input 128: “enrich with the country of the recipient, a custom field ‘recipient-code’ that is a substring of the first 4 letters of the first name and year of birth of the recipient, the count of the emails that are opened by the recipient in the last month, and the orders in the last week sorted by date,” is provided to the machine learning model 126 during task breakdown 116 operations. The machine learning model 126, continuing this example, generates an output indicating segments (e.g., an atomic task) and conditions (e.g., a subtask) such as:
Segment 1:
   enrich_condition: Enrich with the country of the recipients,
   label: Country
Segment 2:
   enrich_condition: Enrich with the first name and year of birth of the recipients,
   label: Recipient Code,
   functional condition:
      type: formula,
      text: Create a custom field ‘recipient-code’ that is a substring of the first 4 letters of the first name and year of birth of the recipient,
      formula: SUBSTRING(first_name, 1, 4)+year_of_birth
Segment 3:
   enrich_condition: Enrich with the deliveries received by the recipients,
   label: Opened Emails Count,
   filter_condition: Filter that delivery type or channel is email, and the email is opened, and the email is received in the last 30 days,
   functional condition:
      type: aggregate,
      text: Get the deliveries received by the recipients,
      formula: count of deliveries
Segment 4:
   enrich_condition: Enrich with the orders of the recipients,
   label: Orders,
   filter_condition: Filter that the order is placed in the last 7 days,
   sort condition:
      text: Sort the orders based on the order date,

In various embodiments, the workflow assistant tool 104 executes condition-specific pipelines that are designed to handle specific conditions (e.g., subtasks) such as enrichment, functional operations, filtering, and sorting. For example, the workflow assistant tool 104 generates inputs (e.g., prompts) for the machine learning model to process the conditions for the segments extracted from the user input. In various embodiments, the enrichment condition-specific pipeline executes search of the database 130 to identify the tables and columns in the database that contain the required data. For example, a prompt including examples is provided to the machine learning model 126, which tasks the machine learning model 126 with identifying the column names that are needed to perform the enrich task.

In another embodiment, the functional condition-specific pipeline determines the operations to be performed on data (e.g., enriched data), including the type of operation (e.g., aggregation, formula, etc.), and the description and the logic to be applied during the operation. For example, the machine learning model is prompted to generate the operation, the type of operations, the description of the operation, and the logic of the operation. Furthermore, in various embodiments, the machine learning model 126 generates a domain-specific formula and/or operation. For example, a formula generated by the machine learning model 126 corresponding to the operation and/or the relevant tables is provided as context to a second machine learning model along with a list of functions and/or operation available to the application 108 and/or a service of the computing resource service provider 120. Continuing this example, the second machine learning model generates the functional condition (e.g., the subtask) specific to the application 108 that will execute the functional condition.

In various embodiments, the filtering condition-specific pipeline determines which records to filter out. In an example, the machine learning model 126 determines filtering criteria based on the information extracted from the user input 128 (e.g., the text descriptions in the conditions as shown above). In various embodiments, the machine learning model 126 generates expressions corresponding to the filtering conditions. In various embodiments, the sorting condition-specific pipeline determines an order in which the data should be presented. For example, the machine learning model 126 identifies the columns for sorting and the sorting direction.

In various embodiments, the filtering conditions are used in a variety of different workflow activities such as a query activity, a split activity, report generation, delivery filtering, audience creation, and the enrich activity. Furthermore, in such embodiments the JSON representation of the “where” structure of the filtering activity contains nested conditions with complex expressions that quickly exhaust and/or exceed the output token limits of the machine learning model 126. Therefore, in such embodiments, chain-of-thought (CoT) prompting is used to cause the machine learning model 126 to generate a compact representation of the “where” clause associated with the filtering condition. For example, the workflow assistant tool 104 breaks down the filter condition subtask into a series of logical steps to enable the machine learning model 126 to generate the compact representation.

In various embodiments, this process begins by defining a conditional hierarchy, which identifies a main table (e.g., a targeting dimension) and the relationships between other tables that are associated with the query construction. For example, if the task is to filter recipients based on their email-open logs, the main table is “nms:recipient,” and the related tables include “nms:tracking_log_recipient” and “nms:tracking_url.” Continuing this example, the task is broken down into individual components, identifying the relevant tables and columns for the filtering condition based on task requirements extracted from the user input 128 by the machine learning model 126. For instance, modifying the task in the example above to filter recipients who opened emails in the last month, the relevant tables would be the same, and the relevant columns would include “date” (e.g., to filter by the last month) and type (e.g., to filter by open).

In various embodiments, the operators (e.g., “=,” “>,” “<,” “IN,” “AND,” “OR,” etc.), functions (e.g., “Count,” “Sum,” etc.), and set operators (e.g., “EXISTS,” “NOT EXISTS,” etc.) specific to the application 108 are provided to the machine learning model 126 for selection. For example, the operations, functions, set operations, and/or other features provided by the application 108 are included in a CoT prompt to the machine learning model 126 including the subtask indicated in the condition. In the specific example above to filter email-open logs, the representation of the condition generated by the machine learning model 126 includes “(YearAndMonth(@logDate)>YearAndMonth(MonthsAgo(1)) AND [url/@type]=2” where the machine learning model 126 combines individual conditions using logical operators (e.g., the operators included in the CoT prompting) and groups the conditions (e.g., using brackets, parentheticals, etc.) to ensure the query is syntactically correct and coherent.

In various embodiments, the compact representation of the filtering condition is converted to the required DSL. For example, the filtering condition above is represented in the following compact representation: “(#O# <table_name1> #C# <set_operator> (<condition>),” where #O# and #C# represent brackets, <table_name1> is the table name, <set_operator> is the operator (EXISTS, NOT EXISTS, etc.), and <condition> is the combination of conditions. Returning to the example above, the filtering condition would have the representation: “(#O# nms:tracking_log_recipient #C# EXISTS ((YearAndMonth(@logDate)>YearAndMonth(MonthsAgo(1)) AND [url/@type]=2).”

In various embodiments, the conditions are simple, complex, nested, function-based, or count-based. For example, a simple condition includes a column name, an operator, and a value. In other examples, a complex condition includes multiple simple conditions using logical operations. Furthermore, next conditions, in various examples, include a table name followed by a set operator. Function-based conditions, in various embodiments, apply a function to a column of a table. Lastly, in some embodiments, count-based conditions count rows in a table that satisfy a specified criteria (e.g., that include a particular value, are above a threshold, etc.).

In various embodiments, once the machine learning model 126 has generated the compact representation for the conditions of the segments (e.g., query expression) representing the user input 128, the workflow assistant tool 104 or component thereof (e.g., the machine learning model 126) converts the compact representation to the structured data object 118. For example, the conversion of the query expression in compact representation, such as the filtering condition in the example above, to XML, involves a structured parsing mechanism that translates the generated query expressions into a domain-specific language (DSL) format. In various embodiments, the parsing process involves expanding the query expression into a structured format using a breadth-first search (BFS) algorithm to identify the shortest path between related tables in the schema to ensure that the relationships between tables are accurately represented in the query expression. In such embodiments, the expanded query expression is then parsed into XML by converting the custom markers and compact representation into XML tags and attributes. For example, the expression #O# nms:recipient #C# EXISTS (YearAndMonth(@logDate)>YearAndMonth(MonthsAgo(1)) AND [url/@type]=2) is converted into an XML format that represents the same logical conditions and relationships.

In various embodiments, the parsing mechanism includes error checking to ensure that the generated XML is syntactically correct and adheres to the required DSL format. For example, the error checking involves validating the schema names, column names, and functions used in the query expression against a predefined list of valid schemas, columns, and functions.

Once the structured data object 118 is generated, the workflow assistant tool 104 performs validation and correction 124 of the structured data object 118. For example, the machine learning model 126 performs validation, error detection, and self-correction. In various embodiments, validation includes checking the generated query expressions included in the structured data object 118 against the schema and a list of valid functions and operators associated with the application 108. For example, the validation operation ensures that the schema names, column names, and functions used in the query expression are correct and that the relationships between tables are accurately represented. In an embodiment, if an error is detected, such as invalid schema names or incorrect linking between tables, the errors are logged, and the query expression is marked for correction.

In various embodiments, the correction mechanism uses a self-correction pipeline that leverages the capabilities of the machine learning model 126. For example, as a result of detecting an error, the machine learning model 126 is prompted with the error details and the possible alternatives. Continuing this example, the machine learning model 126 then generates a corrected version of the query expression based on the provided alternatives. In various embodiments, the correction process continues iteratively until the query expressions are validated and no errors are detected. For example, if the initial query expression contains an invalid column name, the machine learning model 126 is prompted with the error details and a list of valid column names. The machine learning model 126, continuing this example, generates a corrected query expression using one of the valid column names and the corrected expression is then revalidated, and the process repeats until the query expressions represented in the structured data object 118 are accurate and valid. In various embodiments, the machine learning model 126 is provided with all of the column names to correct the error. In other embodiments, the machine learning model 126 is provided with a certain number of schemas that are relevant to the query (e.g., the top ten most relevant schemas determined based on the annotated schemas 122). Furthermore, in some embodiments where the number of relevant schemas does not include the correct column name, the number of relevant schemas provided to the machine learning model 126 is increased. For example, in response to the top ten most relevant schemas not including the valid column name, the workflow assistant tool 104 provides the top twenty most relevant schemas (e.g., determined by at least determines the cosine similarity between the query and the annotated schemas 122) to the machine learning model 126.

In various embodiments, the correction process includes a BFS search to identify alternative paths between tables based on the initial path indicated in the query expression being invalid. Finally, in various embodiments, the corrected query expressions are then converted into XML, JSON, or other structured data object using the parsing mechanism described above.

FIG. 2 depicts in environment 200 in which a workflow assistant tool utilizes a user input 228 to generate a workflow activity encoded in a structured data object 238, in accordance with at least one embodiment. In various embodiments, the user input 228 is obtained from an application, such as the application 108 described above in connection with FIG. 1. In addition, in an embodiment, the user input 228 includes a natural language query and/or description of a workflow activity to be generated on behalf of a user. For example, the workflow activity defines a set of operations on data, a result, or another natural language description of workflow activity. In various embodiments, the workflow activities are designed to perform specific operations within a workflow, such as filtering an audience, splitting the audience into multiple segments, enriching the workflow with additional data, sending deliveries across various channels, analyzing data, providing insights, and other functions and/or operations enabled by the application. In one example, a workflow activity interacts with the data model, which includes database tables, columns, and other internal structures.

In various embodiments, the user input 228 is provided to a machine learning model 226A, such as an LLM, to determine an intent of the user and/or the workflow activity the user is attempting to generate using the workflow assistant tool. In various embodiments, the machine learning model 226A is prompted (e.g., provided as an input) with the user input 228 and a description of a task. In such embodiments, the machine learning model 226A performs task expansion and breakdown into mutually exclusive segments 216 based on the user input 228. For example, the machine learning model 226A is tasked with expanding the user input 228 into a set of segments 220A-220C, where the segments include a set of conditions. Furthermore, the machine learning model 226A breaks down the segments into subtasks 218 (e.g., conditions). As illustrated in FIG. 2, for example, the segment 220B includes an enrich condition 246A, a functional condition 246B, a filtering condition 246C, and a sort condition 246D. Although the segment 220B, in this example, includes four conditions, the segments (e.g., 220A-220C) can include any number of conditions including conditions of the same type. For example, segment three 220C includes two functional conditions and no other condition types.

In various embodiments, the machine learning model 226A generates task vector embeddings 208 representing the set of segments 220A-220C and set of conditions 246A-246D outputted by the machine learning model 226A. In addition, a set of schema vector embeddings 222, in various embodiments, are generated, maintained, or otherwise stored in a data store and compared 212 to the task vector embeddings. For example, a database schema and/or annotations are provided to the machine learning model 226A or other model to generate the schema vector embeddings. In various embodiments, a similarity between the task vector embeddings 208 and the schema vector embeddings 222 is determined. For example, the cosine similarity between the task vector embeddings 208 and the schema vector embeddings 222 is determined. In an embodiment, the search results 214 include the determined similarity between the task vector embeddings 208 and the schema vector embeddings 222. For example, the search results include a set of values indicating the similarity between the schema vector embeddings and the task vector embeddings 208.

In various embodiments, the workflow assistant tool determines the relevant schemas 236 based on the search results 214. For example, the schema vector embedding with the highest similarity score and/or value for segments of the set of segments 220A-220C and/or conditions for the set of conditions 246A-246D is determined to be the relevant schemas 236.

In various embodiments, the segments 220A-220C and relevant schemas 236 corresponding to the segments are provided as input to a machine learning model 226B. In an embodiment, the machine learning model 226B is a distinct instance of the machine learning model 226A. In other embodiments, the machine learning model 226A and the machine learning model 226B are the same model. As described above, in various embodiments, the workflow assistant tool generates a prompt (e.g., an input) to the machine learning model 226B including the segment and condition description generated by the machine learning model 226A, the relevant schemas 236, examples of the desired output, functions available to the application, or other information to enable the machine learning model 226B to generate an output 230 representing the workflow activity that is converted into the structured data object 238. In one example, CoT prompting is used to enable the machine learning model 226B to generate the output 230.

In various embodiments, the machine learning model 226B processes the segment using condition-specific pipelines to create the workflow activity. In an embodiment, the workflow assistant tool performs validation and correction 224 of the output 230. In one example, the workflow assistant tool checks the output 230 and/or expression in the output 230 against a database schema and a list of functions and/or operators of the application to ensure that the schema names, column names, and functions used in the output 230 are correct and that the relationships between tables are accurately represented. In an embodiment, if any errors are detected, such as invalid schema names or incorrect linking between tables, the errors are logged, and the output 230 or portion thereof (e.g., the expression that generates the error) is marked for correction.

The correction mechanism, in various embodiments, uses a self-correction pipeline that leverages the capabilities of the machine learning model 226B. For example, in response to an error, the machine learning model 226B is prompted with the error details and possible alternatives. The machine learning model 226B, continuing this example, then generates a corrected version of the expression included in the output 230 based on the provided alternatives. In various embodiments, this iterative process continues until the output 230 is validated and free of errors.

Additionally, in some embodiments, the correction mechanism includes a BFS to identify alternative paths between tables if the initial path is invalid, ensuring that the expression accurately represents the relationships between tables and adheres to the required DSL format. For example, a specific prompt including instructions, rules, and/or examples is used for the various condition types. The machine learning model 226B, in various embodiments, converts output to XML using a rule-based parsing mechanism, tokenizing the output 230 and iterating over the tokens to generate the required XML structure (e.g., the structured data object).

FIG. 3 is an example user interface 300 of an application that provides a work space 320 and access to a workflow assistant tool, according to some embodiments. The user interface 300 includes a query box 318 user interface element to allow users to provide a user input 328 to the workflow assistant tool (e.g., the workflow assistant tool 104 described above in connection with FIG. 1). Each of the user interfaces 300, 400, 500, and 600 and any other user interfaces described herein comprise interfaces with applications provided using a combination of hardware, firmware, and/or software. The user interfaces can includes additional user interface elements to enable users to interact with an application such as the application 108 of FIG. 1.

Furthermore, in some embodiments, a machine learning model of the workflow assistant tool generates a workflow activity based on the user input 328. In some embodiments, the application allows users to interact with a marketing and/or an analytics service and execute workflow activities generated by the machine learning model of the workflow assistant tool. For example, as illustrated in FIG. 3, the user input 328 includes a query: “fetch audience who have products worth more than $100, added to either their abandoned cart or their wish list over the last 2 weeks.” As described above, in various embodiments, the machine learning model of the workflow assistant tool expands and/or breaks down the user input 328 into a set of segments including a set of conditions.

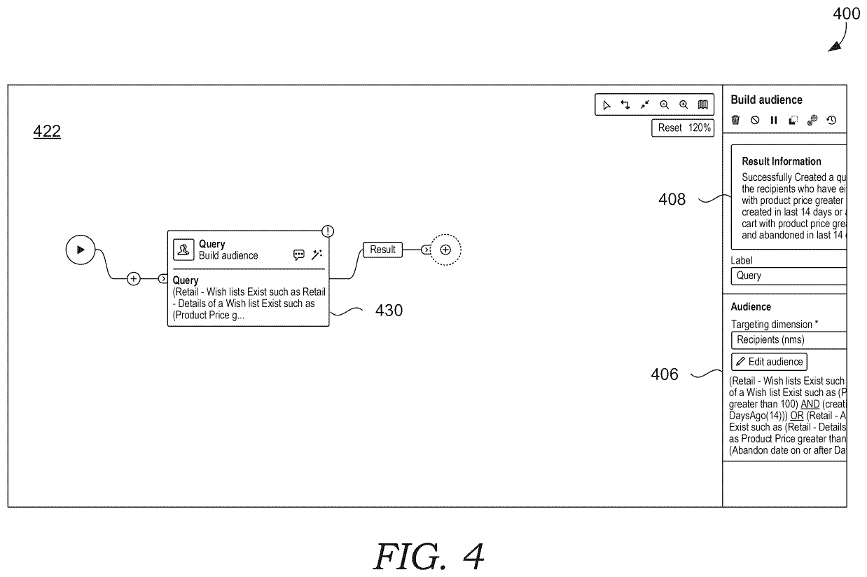

Turing now to FIG. 4, FIG. 4 is an example user interface 400 of an application that depicts a workflow activity 430, according to some embodiments. For example, the workflow activity 430 is generated based on the user input 328 of FIG. 3. The user interface 400 includes a work space 422 that depicts the workflow activity 430, a result panel 408, and an edit panel 406. In various embodiments, the result panel 408 indicates a description of the result of the machine learning model and/or workflow assistant tool to generate the workflow activity 430 based on the user input. For example, the result panel 408 indicates whether the workflow activity 430 was successfully generated. Furthermore, in various embodiments, the edit panel 406 allows the user to edit the workflow activity 430.

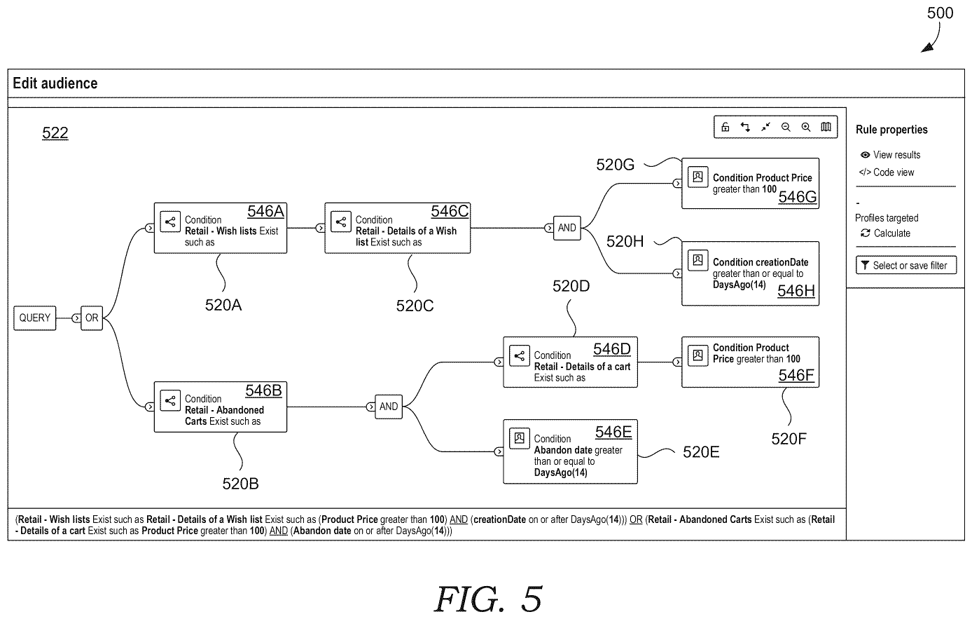

In various embodiments, workflow activity 430 includes a set of segments, where a particular segment indicates an atomic task described in the user input (e.g., the user input 328) and the segments include a set of conditions, where a particular condition indicates an atomic subtask described in the user input. For example, FIG. 5 depicts a user interface 500 of an application that includes a representation of the workflow activity 430 in a work space 522 that includes an expanded view of the set of segments 520A-520H and set of conditions 546A-546H, according to some embodiments. In various embodiments, a machine learning model generates the set of segments 520A-520H and set of conditions 546A-546H based on the user input (e.g., the user input 328). Furthermore, the user can edit, via the work space 522, the set of segments 520A-520H and/or set of conditions 546A-546H

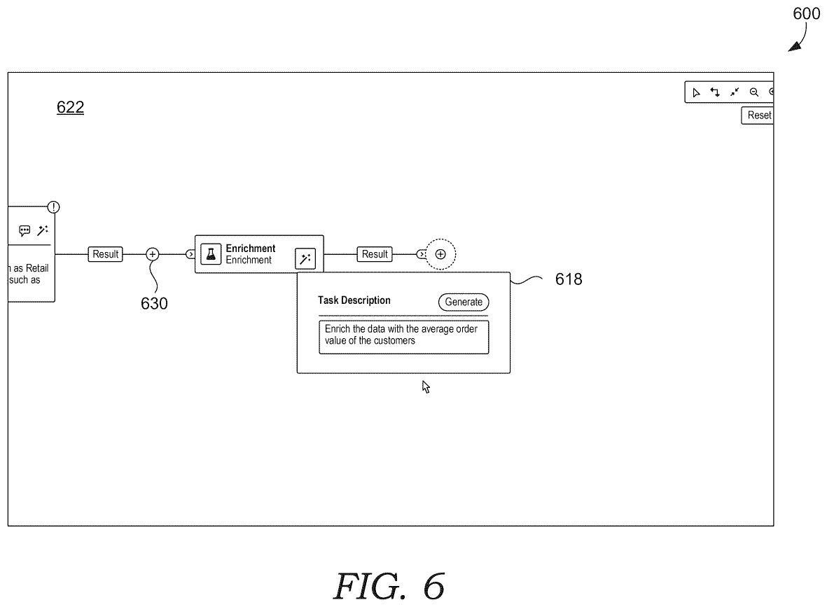

FIG. 6 depicts a user interface 600 of an application that provides a work space 622 and access to a workflow assistant tool, according to some embodiments. The user interface 600 includes a query box 618 user interface element to allow users to provide a user input to the workflow assistant tool. For example, the user can select the “plus” icon 630 to add a new workflow activity to the work space 622. In various embodiments, selection of the icon 630 causes the query box 618 to be displayed within the work space 622. In one example, the user selects an enrichment workflow activity to enrich the data generated by the workflow activity 430 described above in FIG. 4.

Furthermore, in some embodiments, a machine learning model of the workflow assistant tool generates a workflow activity based on the user input. In some embodiments, the application allows users to interact with a marketing and/or an analytics service and execute workflow activities generated by the machine learning model of the workflow assistant tool. For example, as illustrated in FIG. 3, the user input 328 includes a query: “fetch audience who have products worth more than $100, added to either their abandoned cart or their wish list over the last 2 weeks.” As described above, in various embodiments, the machine learning model of the workflow assistant tool expands and/or breaks down the user input 328 into a set of segments including a set of conditions.

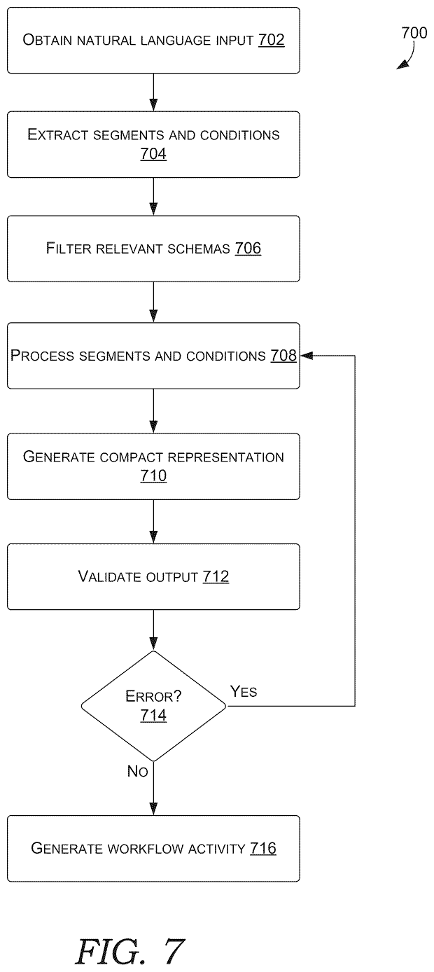

FIG. 7 is a flow diagram showing a method 700 for generating a workflow activity based on a natural language input in accordance with at least one embodiment. The method 700 can be performed, for instance, by the workflow assistant tool 104 of FIG. 1. Each block of the method 700 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 702, the system implementing the method 700 obtains a natural language input. As described above in connection with FIG. 1, in various embodiments, a user provides a natural language query and/or other input to the user interface of an application indicating a workflow activity the user is attempting to generate. For example, a virtual assistant, a query box, and/or other user interface elements are used obtain the user input, which includes a natural language description of a workflow activity.

At block 704, the system implementing the method 700 extracts a set of segments and a set conditions for the segments of the set of segments. For example, the user input is provided in a prompt to a machine learning model that is tasked with generating the set of segments and the set of conditions. Continuing this example, the machine learning model breaks down the user input into independent segments that correspond to specific conditions or operations. In a specific example, given the user input: “Enrich with the country of the recipient, a custom field ‘recipient-code’ that is a substring of the first 4 letters of the first name and the year of birth of the recipient, the count of the emails that were opened by the recipient in the last month, and the orders in the last week sorted by date,” the machine learning model generates a set of segments including enriching with the country of the recipient, creating a custom field “recipient-code,” counting the emails opened by the recipient in the last month, and fetching the orders in the last week sorted by date.

At block 706, the system implementing the method 700 filters relevant schemas. In various embodiments, the workflow assistant tool identifies the database schemas that are most relevant to the input task. For example, semantic vector embeddings for the user input and the database are compared, and database tables with the most similar semantic vector embeddings to the user input are selected. Returning to the example above, the relevant schemas include nms:recipient for recipient information, nms:country for country information, nms:trackingLogRcp and nms:trackingUrl for email tracking logs, and luma: order for order information.

At block 708, the system implementing the method 700 processes the segments using condition-specific pipelines to identify the necessary tables, columns, and operations. In the example above, to create the custom field “recipient-code,” the system implementing the method 700 identifies the nms:recipient schema and the @firstName and @birthDate columns, generating the formula JuxtWords3(Substring([target/@firstName], 1, 4), ToString(Year([target/@birthDate]))). In various embodiments, the various condition types are processed by the machine learning model based on a set of rules and/or instructions provided to the machine learning model.

At block 710, the system implementing the method 700 generates a compact representation of the results generated at block 708—for example, a compact representation of where clauses for filtering conditions using a custom format are generated. In various embodiments, the workflow assistant tool creates a concise representation that enables parsing of the output of the machine learning model. For instance, the condition “Count the emails opened by the recipient in the last 1 month” is represented as “(#O# nms:trackingLogRcp #C# EXISTS (YearAndMonth(@logDate)>YearAndMonth(MonthsAgo(1)) AND [url/@type]=2))” based on a syntax defined to the machine learning model.

At block 712, the system implementing the method 700 validates the output. In various embodiments, validation and correction are performed to ensure the accuracy of the generated query expression. For example, the system implementing the method 700 validates the query expression against the database schema and corrects any errors using a self-correction pipeline. At block 714, if an error is detected, the system implementing the method 700 returns block 708 and provides the error information. In particular, if the initial query expression contains an invalid column name, for example, the system implementing the method 700 returns to block 708 and prompts the machine learning model with the error details and possible alternatives and causes the machine learning model to generate a corrected version. In various embodiments, this process continues iteratively until the expression is accurate (e.g., no error is returned at block 714).

At block 714, if no error is detected, the system implementing the method 700 continues to block 716 and generates the workflow activity. In various embodiments, the system implementing the method 700 generates the workflow activity by converting the output of the machine learning model to a DSL—for example, the validated and corrected query expression into XML format such that the query expression can be executed by an application. In some embodiments, if errors continue to be detected, the system executing the method 700, returns to block 706 to obtain additional schemas. For example, if the correct schemas information is not included in the relevant schemas determined in block 706, the system executing the method 700 obtains additional relevant schemes. Continuing this example, the system executing the method 700 obtains the top twenty most relevant schemes. In other examples, the system executing the method 700 obtains the entire schema.

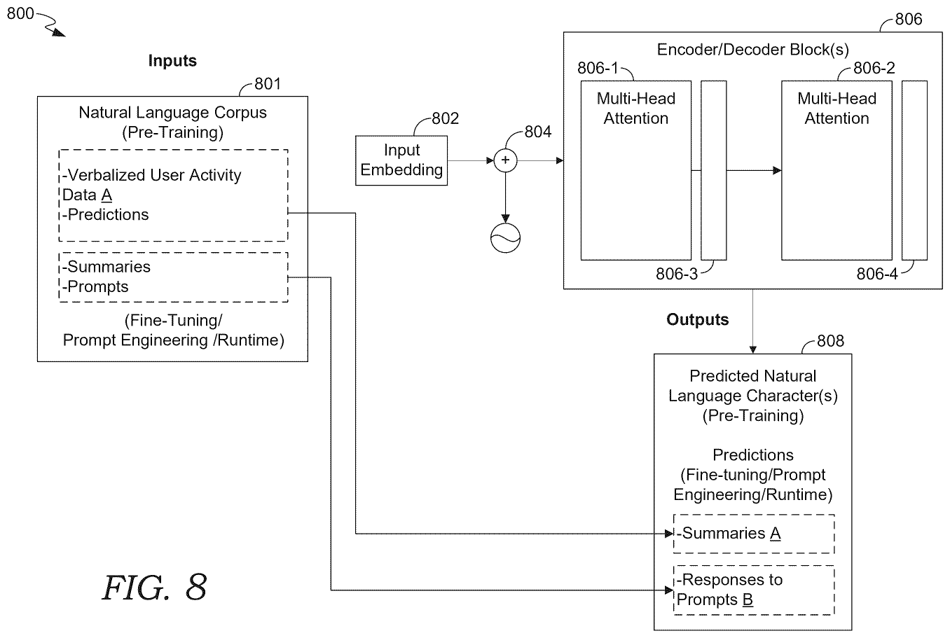

FIG. 8 is a block diagram of a Large Language Model 800 (e.g., a BERT model or GPT-4 model) that uses particular inputs to make particular predictions (e.g., answers to questions), according to some embodiments. In some embodiments, this model 800 represents or includes the functionality as described with respect to the machine learning model(s) 126 of FIG. 1. In various embodiments, the language model 800 includes one or more encoders and/or decoder blocks 806 (or any transformer or portion thereof).

First, a natural language corpus (e.g., various WIKIPEDIA English words or BooksCorpus) of the inputs 801 are converted into tokens and then feature vectors and embedded into an input embedding 802 to derive meaning of individual natural language words (for example, English semantics) during pre-training. In some embodiments, to understand English language, corpus documents, such as text books, periodicals, blogs, social media feeds, and the like are ingested by the language model 800.

In some embodiments, each word or character in the input(s) 801 is mapped into the input embedding 802 in parallel or at the same time, unlike existing long short-term memory (LSTM) models, for example. The input embedding 802 maps a word to a feature vector representing the word. However, the same word (for example, “apple”) in different sentences may have different meanings (for example, brand versus fruit). This is why a positional encoder 804 can be implemented. A positional encoder 804 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector as follows:

$$P {E}_{( p o s , 2 i )} = sin ( pos / 1000 {0}^{2 i / {d}_{m o d e l}} )$$

$$P {E}_{( p o s , 2 i + 1 )} = cos ( pos / 1000 {0}^{2 i / {d}_{m o d e l}} ) .$$

After passing the input(s) 801 through the input embedding 802 and applying the positional encoder 804, the output is a word embedding feature vector, which encodes positional information or context based on the positional encoder 804. These word embedding feature vectors are then passed to the encoder and/or decoder block(s) 806, where they go through a multi-head attention layer 806-1 and a feedforward layer 806-2. The multi-head attention layer 806-1 is generally responsible for focusing or processing certain parts of the feature vectors representing specific portions of the input(s) 801 by generating attention vectors. For example, in Question Answering systems, the multi-head attention layer 806-1 determines how relevant the i^{th} word (or particular word in a sentence) is for answering the question or its relevance to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following formula:

$$Z = softmax ( \frac{Q \cdot {K}^{T}}{\sqrt{Dimension of vector Q , K , or V}} ) \cdot V .$$

For multi-headed attention, there are multiple weight matrices W^{q}, W^{k}, and W^{v} so there are multiple attention vectors Z for every word. However, a neural network may only expect one attention vector per word. Accordingly, another weighted matrix, W^{z}, is used to make sure the output is still an attention vector per word. In some embodiments, after the layers 806-1 and 806-2, there is some form of normalization (for example, batch normalization and/or layer normalization) performed to smoothen out the loss surface, making it easier to optimize while using larger learning rates.

Layers 806-3 and 806-4 represent residual connection and/or normalization layers where normalization recenters and rescales or normalizes the data across the feature dimensions. The feedforward layer 806-2 is a feedforward neural network that is applied to every one of the attention vectors outputted by the multi-head attention layer 806-1. The feedforward layer 806-2 transforms the attention vectors into a form that can be processed by the next encoder block or can make a prediction at 808. For example, given that a document includes the first natural language sequence “the due date is . . . ” the encoder/decoder block(s) 806 predicts that the next natural language sequence will be a specific date or particular words based on past documents that include language identical or similar to the first natural language sequence.

In some embodiments, the encoder/decoder block(s) 806 includes pre-training to learn language (pre-training) and make corresponding predictions. In some embodiments, there is no fine-tuning because some embodiments perform prompt engineering, prompt-tuning, or zero-shot learning. “Prompt engineering” refers to a process of designing or using structured input to the model (referred to as a prompt or prompts) to cause a desired response to be generated by the model. In some embodiments, prompt engineering includes creating the best or optimal prompt, or series of prompts, for the desired user task or output. Accordingly, given a first prompt (which may include target content), if the model produces a first output with a high likelihood of not being the correct response, particular embodiments learn such that a second output (indicative of high likelihood of being the correct response) is always produced when such a first prompt is provided as input. In this way, at model deployment time, no output is ever produced with a low likelihood of being the correct response if the first prompt (or variation thereof) is provided, thereby increasing the accuracy of the model's generative outputs.

Pre-training is performed to understand language, and fine-tuning is performed to learn a specific task, such as learning an answer to a set of questions (in Question Answering systems). In some embodiments, the encoder/decoder block(s) 806 learns what language and context for a word are in pre-training by training on two unsupervised tasks (MLM and NSP) simultaneously or at the same time. In terms of the inputs and outputs, at pre-training, the natural language corpus of the inputs 801 may be various historical documents, such as text books, journals, or periodicals, in order to output the predicted natural language characters in 808 (not make the predictions at runtime or prompt engineering at this point). The encoder/decoder block(s) 806 takes in a sentence, paragraph, or sequence (for example, included in the input[s] 801), with random words being replaced with masks. The goal is to output the value or meaning of the masked tokens. For example, if a line reads, “please [MASK] this document promptly,” the prediction for the “mask” value is “send.” This helps the encoder/decoder block(s) 806 understand the bidirectional context in a sentence, paragraph, or line at a document. In the case of NSP, the encoder/decoder block(s) 806 takes, as input, two or more elements, such as sentences, lines, or paragraphs, and determines, for example, if a second sentence in a document actually follows (for example, is directly below) a first sentence in the document. This helps the encoder/decoder block(s) 806 understand the context across all the elements of a document, not just within a single element. Using both of these together, the encoder/decoder block(s) 806 derives a good understanding of natural language.

In some embodiments, during pre-training, the input to the encoder/decoder block(s) 806 is a set (for example, 2) of masked sentences (sentences for which there are one or more masks), which could alternatively be partial strings or paragraphs. In some embodiments, each word is represented as a token, and some of the tokens are masked. Each token is then converted into a word embedding (for example, 802). At the output side is the binary output for the next sentence prediction. For example, this component may output 1, for example, if masked sentence 2 follows (for example, is directly beneath) masked sentence 1. The output is word feature vectors that correspond to the outputs for the machine learning model functionality. Thus, the number of word feature vectors that are input is the same number of word feature vectors that are output.

In some embodiments, the initial embedding (for example, the input embedding 602) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence numbers (that includes the input [s] 601) that are encoded into a vector (for example, first sentence, second sentence, etc., assuming a top-down and right-to-left approach). The position embeddings are vectors that represent the position of a particular word in such a sentence that can be produced by positional encoder 804. When these three embeddings are added or concatenated together, an embedding vector is generated that is used as input into the encoder/decoder block(s) 806. The segment and position embeddings are used for temporal ordering since all of the vectors are fed into the encoder/decoder block(s) 806 simultaneously and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, once pre-training is performed, the encoder/decoder block(s) 806 performs prompt engineering or fine-tuning on a variety of question and answer datasets by converting different QA formats into a unified sequence-to-sequence format. For example, some embodiments perform the QA task by adding a new question answering head or encoder/decoder block, just the way a masked language model head is added (in pre-training) for performing an MLM task, except that the task is a part of prompt engineering or fine-tuning. This includes the encoder/decoder block(s) 806 processing the inputs 801 (i.e., the verbalized user activity data, the predictions, summaries, and/or prompts) in order to make the predictions and confidence scores as indicated in 808. Prompt engineering, in some embodiments, is the process of crafting and optimizing text prompts for language models to achieve desired outputs. In other words, prompt engineering is the process of mapping prompts (e.g., a question) to the output (e.g., an answer) that it belongs to for training. For example, if a user asks a model to generate a poem about a person fishing on a lake, the expectation is that it will generate a different poem each time. Users may then label the output or answers from best to worst. Such labels are an input to the model to make sure the model is giving more human-like or best answers, while trying to minimize the worst answers (e.g., via reinforcement learning). In some embodiments, a “prompt” as described herein includes one or more of: a request (e.g., a question or instruction [e.g., write a poem]), target content, a command or instruction, and/or more examples (e.g., one-shot or two-shot examples).

In an illustrative example, in some embodiments, the predictions of the output 808 may be generative text, workflow activities, structured data objects, or other data, such as those described above with reference to FIGS. 3-6. Alternative to prompt engineering or fine-tuning, in some embodiments the inputs 801 and outputs 808 represent “runtime” inputs and outputs. Runtime represents a time after which the model 800 has been trained (e.g., via pre-training and/or fine-tuning and/or prompt engineering), tested, and deployed.

An artificial intelligence (AI) system refers to an artificial intelligence computing environment or architecture that includes the infrastructure and components that support the development, training, and deployment of artificial intelligence models. It provides necessary hardware, software, and frameworks for developers to create and run artificial intelligence applications. An artificial intelligence system may be a cloud-based AI solution that leverages cloud computing infrastructure to develop, train, deploy, and manage AI models and applications. AI models may specifically refer to generative AI models that are designed to generate new data or content that is similar to, or in some cases, entirely different from data they are trained on.

Artificial intelligence systems can include transformer models that are capable of running complex neural language processing tasks. Transformer models—also known as Large Language Models (LLMs)—have applications in a wide range of industries. An LLM is a trained deep learning model that can recognize, summarize, translate, predict, and generate content using very large datasets. LLMs and other types of generative AI models are associated with a training phase—where a model is taught to learn patterns, relationships, and knowledge from training datasets—and an inference phase, which includes making predictions, classifications, or generating outputs for real-world tasks or queries.

Unlike convolution neural networks (CNNs), which are typically used for image tasks and mostly rely on convolution operations, transformer models are based on simple general matrix multiplication (GEMM) tasks, which can be further broken down to perform a dot product operation on two vectors. While CNN architectures are typically computationally heavy with a relatively small number of parameters, the architecture of transformer models results in the opposite: a very large number of parameters with a fairly small number of operations. The LLM architecture can create challenges in that performance bottlenecks reside in the memory throughput and capacity rather than the compute engine.

Transformer models operate with memory accesses to retrieve a matrix of weights out of memory, together with a vector (either the input vector or partial result from a previous stage of the model), and multiplying the two. This is true for the model's attention sublayers, the FFN (feedforward network), sublayers, and for the final embedding layer. As vector-matrix multiplication is actually comprised of numerous vector-vector multiplications (dot product), it is fair to say that most memory accesses are used to read two vectors in order to perform a dot product on them. As such, reading out the full vectors is inefficient.

As such, transformer models (also referred to herein as “generative AI models”) require computational resources including processors and memory for the training phase and inference phase. The generative AI models operate with different types of processors (e.g., central processing units [CPUs] or graphics processing units [GPUs]) in architectures that include multi-core CPUs or parallel processors including GPUs and tensor processing units (TPUs). Memory can be used to store model parameters and intermediate data for the training phase and the inference phase. Memory requirements may depend on the size and the architecture of the generative AI models. By way of illustration, an LLM can support an inferencing phase that includes using a trained model to make predictions, draw conclusions, or generate output based on input data or patterns learned during the model's training phase. During the inference phase, an LLM can use DRAM (Dynamic Random-Access Memory) to store various components and data for making inferences. LLMs can store their pre-trained model parameters (e.g., weights and biases of the neural network layers) in DRAM, and when a new input is provided for inference, the model accesses these parameters from DRAM to make predictions.

The inference phase can be divided into two stages: a prompt stage and an auto-regressive stage. The prompt stage can include receiving and processing input as a batch of new tokens as part of the same inference. The prompt stage may operate based on a Key-Value (KV) cache technique, where a KV cache is created for tokens in a batch. During the prompt stage, the input is being digested. The auto-regressive state can include using the model to generate the tokens one by one, based on previous tokens, relying on reading the KV cache of previously processed tokens, and adding the data of only new tokens to the KV cache. This auto-regressive stage includes the model generating a response to the input from the prompt stage.

Referring now to FIG. 9, FIG. 9 provides an example of a computing device in which embodiments of the present disclosure may be employed. Computing device 900 includes bus 910 that directly or indirectly couples the following devices: memory 912, one or more processors 914, one or more presentation components 916, input/output (I/O) ports 918, input/output components 920, and illustrative power supply 922. Bus 910 represents what may be one or more buses (such as an address bus, data bus, or combination thereof). Although the various blocks of FIG. 9 are shown with lines for the sake of clarity, in reality, delineating various components is not so clear, and metaphorically, the lines would more accurately be gray and fuzzy. For example, one may consider a presentation component such as a display device to be an input/output (I/O) component. Also, processors have memory. The inventors recognize that such is the nature of the art and reiterate that the diagram of FIG. 9 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 9 and make reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 900. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, infrared, and other wireless media. Combinations of any of the above should also be included within the scope of computer-readable media.

Memory 912 includes computer storage media in the form of volatile and/or nonvolatile memory. As depicted, memory 912 includes instructions 924. Instructions 924, when executed by processor(s) 914, are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which may be built-in. Illustrative components include a microphone, joystick, game pad, satellite dish, scanner, printer, wireless device, etc. I/O components 920 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 900. Computing device 900 may be equipped with depth cameras, such as stereoscopic camera systems, infrared camera systems, camera systems, and combinations of these, for gesture detection and recognition. Additionally, computing device 900 may be equipped with accelerometers or gyroscopes that enable detection of motion. The output of the accelerometers or gyroscopes may be provided to the display of computing device 900 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order to not obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further subparts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B, and C” means “(A), (B), (C), (A and B), (A and C), (B and C), or (A, B and C).”

What is claimed is:

1. An artificial intelligence (AI)-based system, comprising:
a workflow assistant tool having:
a machine learning model; and
an interface element that obtains a user input through a user interface of an application that provides access to workflow activities, wherein a workflow activity is generated by the machine learning model based on the user input, the user input including at least a natural language description of the workflow activity to be generated by the workflow assistant tool, the workflow activity generated by the machine learning model by at least:
causing the machine learning model, based on the user input, to generate a set of segments, where a first segment of the set of segments represents a task indicated in the user input and includes a set of conditions, where a first condition of the set of conditions represents a subtask indicated in the user input;
determining a set of relevant schemas based on a comparison of table semantic vector embeddings and user input semantic vector embeddings, the user input semantic vector embeddings generated by the machine learning model based on the user input;
causing the machine learning model to generate a representation of the set of segments; and
generating a structured data object executable by the application in a domain-specific language associated with the application based on the representation of the set of segments; and
a relevant schema data store that stores the table semantic vector embeddings generated based on annotated tables stored in a database, where the database includes data processed by the application during execution of the workflow activity.

2. The AI-based system of claim 1, wherein causing the machine learning model, based on the user input, to generate the set of segments further comprises providing the machine learning model with a prompt including the user input and a set of operations executable by the application.

3. The AI-based system of claim 1, wherein the comparison of the table semantic vector embeddings and the user input semantic vector embeddings further comprises a cosine similarity between the table semantic vector embeddings and the user input semantic vector embeddings.

4. The AI-based system of claim 3, wherein determining the set of relevant schemas further comprises selecting a table semantic vector embedding of the table semantic vector embeddings that has a highest cosine similarity value.

5. The AI-based system of claim 1, wherein causing the machine learning model to generate the representation of the set of segments further comprises causing the machine learning model to generate a first representation of the first segment by prompting the machine learning model with a portion of the user input associated with the first condition of the set of conditions, a relevant schema of the set of relevant schemas containing data associated with the first condition, and a set of operations executable by the application.

6. The AI-based system of claim 1, wherein causing the machine learning model to generate the representation of the set of segments further comprises causing the machine learning model to generate a first representation of the first segment by prompting the machine learning model with a set of rules for generating the representation.

7. The AI-based system of claim 6, wherein the set of rules are provided to the machine learning model using Chain-of-Thought prompting.

8. A non-transitory computer-readable medium storing executable instructions embodied thereon, that, as a result of being executed by a processing device, cause the processing device to perform operations comprising:
obtaining a natural language input defining a workflow activity associated with an application, where the workflow activity causes an operation to be performed using data from one or more tables of a database;
providing a machine learning model with a first prompt including the natural language input to obtain from the machine learning model a set of segments and a set of conditions, where segments of the set of segments define tasks indicated in the natural language input and conditions of the set of conditions define corresponding subtasks;
providing the machine learning model with a second prompt to obtain from the machine learning model an output representing the workflow activity, where the second prompt includes a set of relevant schemas representing the set of segments, the set of conditions, and a set of operations associated with the application; and
generating a structured data object that encodes the workflow activity based on the output.

9. The medium of claim 8, wherein the operations further comprise validating the output based on the one or more tables.

10. The medium of claim 8, wherein the second prompt further includes a set of rules defining a representation of the set of segments and the set of conditions.

11. The medium of claim 10, wherein generating the structured data object further comprises parsing the representation based on a domain-specific language associated with the application.

12. The medium of claim 11, wherein the structured data object is executable by the application to generate the workflow activity.

13. The medium of claim 8, wherein the set of relevant schemas are determined based at least in part on a first set of vector embeddings generated based on the one or more tables of the database and a second set of vector embeddings generated based on the set of segments and the set of conditions.

14. The medium of claim 13, wherein the machine learning model generates the first set of vector embeddings based on a set of annotations associated with the one or more tables.

15. The medium of claim 14, wherein the set of annotations are generated by the machine learning model.

16. A method comprising:
obtaining a user input including a natural language query describing a workflow activity to be executed by an application;
causing a machine learning model to generate a set of segments based on the natural language query, where a first segment of the set of segments includes a first task and a second segment of the set of segments includes a second task, the first task and the second task are distinct tasks indicated in the natural language query, and the first segment includes a set of conditions representing subtasks of the first task;
determining a set of relevant schemas based on a set of vector embeddings representing the set of segments;
processing the set of segments to generate a prompt to the machine learning model that, as a result of being processed by the machine learning model, causes the machine learning model to generate an output representing the workflow activity; and
generating an executable data object that encodes the workflow activity based on the output.

17. The method of claim 16, wherein the method further comprises validating the output by at least detecting an incorrect link between schemas of the set of relevant schemas, detecting an incorrect operation associated with the application, or detecting an invalid column name.

18. The method of claim 17, wherein the method further comprises, in response to validating the output detecting an error, prompting the machine learning model with the error and a set of alternatives.

19. The method of claim 18, wherein the set of alternatives includes at least one of: a set of columns included in a relevant schema of the set of relevant schemas, an alternative operation associated with the application, and an alternative schema name.

20. The method of claim 16, wherein the prompt includes a set of operations associated with the application and a set of rules associated with the set of conditions.
